(19) United States
(12) Patent Application Publication
(10) Pub. No.: US 2017/0272451 A1
(43) Pub. Date: Sep. 21, 2017

(54) MONITORING APPARATUS AND COMMUNICATION SYSTEM

(71) Applicant: HONDA MOTOR CO., LTD., Tokyo (JP)

(72) Inventor: Kazuyoshi Wakita, Wako-shi (JP)

(21) Appl. No.: 15/456,151

(22) Filed: Mar. 10, 2017

(30) Foreign Application Priority Data
Mar. 15, 2016 (JP) 2016-051517

(51) Int. Cl. H04L 29/06; G06F 11/30

(52) U.S. Cl. CPC H04L 63/1416; G06F 11/3013; G06F 11/3051; G06F 11/3006; H04L 2012/40215

(57) ABSTRACT

A monitoring apparatus capable of efficiently disabling, when an invalid frame is detected in an in-vehicle network, the invalid frame by a simple method, for example, includes a reception unit configured to receive a frame from a communication network, a determination unit configured to determine whether the frame received by the reception unit is a valid frame or an invalid frame which is not a valid frame, and a transmission unit configured to transmit, if the determination unit determines that the received frame is an invalid frame, a frame including information identical to that included in the valid frame.

### CROSS-REFERENCE TO RELATED APPLICATION

This application is based upon and claims the benefit of priority from the prior Japanese Patent Application No. 2016-051517, filed on Mar. 15, 2016, the entire contents of which are incorporated herein by reference.

### BACKGROUND OF THE INVENTION

Field of the Invention

The present invention relates to a monitoring apparatus and, more specifically, to a network monitoring apparatus for monitoring the operation status of a network mounted on a vehicle.

Description of the Related Art

Electronic control has been introduced in recent vehicles. ECUs for controlling the respective units of a vehicle are connected to, for example, a common bus according to an interface complying with the standard of a controller area network (CAN), and communicate with each other. Originally, an in-vehicle network is a network closed in a vehicle, and is isolated from the outside. However, it is necessary to communicate with the outside to update software for the purpose of improving the functions of the ECUs for maintenance management. Consequently, even the in-vehicle network has been required to ensure the security.

Therefore, conventionally, there has been proposed various techniques for ensuring the security even in an in-vehicle network.

For example, Japanese Patent Laid-Open No. 2014-226946 proposes an arrangement in which an abnormal frame is detected from frames transmitted/received between ECUs in an in-vehicle network, and a transmission ID associated with the frame is replaced by a preset different ID. Japanese Patent Laid-Open No. 2014-236248 proposes an arrangement in which each ECU includes a communication control unit and an I/O control unit, which are parallelly connected to a network bus, and the I/O control unit detects an invalid frame, and disables the invalid frame before receiving the ACK field of the invalid frame.

Furthermore, Japanese Patent Laid-Open No. 2015-103163 proposes an arrangement in which when an in-vehicle network communicates with an external apparatus, transmission/reception data is encrypted and added to a transmission/reception frame.

The above conventional examples, however, have the following problems.

The system proposed in Japanese Patent Laid-Open No. 2014-226946 is configured to, if it is previously attacked, establish transmission/reception by changing an identification ID transmitted/received in the in-vehicle network. Thus, the ECUs need to establish communication in a state in which a plurality of identification IDs used for transmission/reception are prepared, and it is thus necessary to hold a lot of information, resulting in a large size of software. Furthermore, if a frame using an identification ID prepared in advance is transmitted/received, a reception apparatus cannot determine whether the frame is a valid or invalid frame. Vulnerability to a sophisticated illegal attack is unwantedly revealed.

In the arrangement proposed in Japanese Patent Laid-Open No. 2014-236248, it is possible to prevent a reception apparatus from acquiring invalid data by detecting an invalid data and destroying it before transmission completion (ACK response) of transmission data of the invalid frame. However, since transmission is not complete on the side of a transmission apparatus (invalid apparatus), error retransmission is unwantedly automatically executed for the invalid data. As a result, the invalid frame is received many times, and processing of detecting the invalid frame and destroying it before transmission completion (ACK response) is unwantedly repeated. Thus, the in-vehicle network enters a saturated state, and even transmission/reception of a valid frame is disabled. This may adversely influence the behavior of the vehicle, thereby causing a serious problem.

In the system proposed in Japanese Patent Laid-Open No. 2015-103163, a MAC value or a simple cypher is added to a transmission/reception frame. If the additional information is processed and executed, the processing load of a control apparatus increases, or the cost of the control apparatus increases. Furthermore, if a clever attacker illegally acquires an encryption key or authentication data (MAC value) calculation method, even if more sophisticated control is executed, complete spoofing may be established, and the vehicle may be taken over.

### SUMMARY OF THE INVENTION

The present invention has been made in consideration of the above conventional examples, and has as its objective to provide a monitoring apparatus capable of efficiently disabling, when an invalid frame is detected in an in-vehicle network, the invalid frame by a simple method, and a communication system.

To achieve the above objective, a monitoring apparatus according to the present invention has the following arrangement.

According to the first aspect of the present invention, there is provided a monitoring apparatus for monitoring a frame transmitted/received via a communication network, comprising: a reception unit configured to receive the frame from the communication network; a determination unit configured to determine whether the frame received by the reception unit is a valid frame or an invalid frame which is not a valid frame; and a transmission unit configured to transmit, if the determination unit determines that the received frame is an invalid frame, a frame including information identical to that included in the valid frame.

According to the second aspect of the present invention, there is provided a communication system comprising: a plurality of control apparatuses, each integrating a monitoring apparatus, and transmitting/receiving a frame via a communication path, wherein the monitoring apparatus monitors the frame transmitted/received via the communication path from a communication network, and comprises: a reception unit configured to receive the frame from the communication network; a determination unit configured to determine whether the frame received by the reception unit is a valid frame or an invalid frame which is not a valid frame; and a transmission unit configured to transmit, if the determination unit determines that the received frame is an invalid frame, a frame including information identical to that included in the valid frame.

According to the third aspect of the present invention, there is provided a communication system comprising: a monitoring apparatus configured to be connected to a communication path; and a control apparatus configured to transmit/receive a frame via the communication path, wherein the monitoring apparatus monitors a frame transmitted/received via the communication path from a communication network, and comprises: a reception unit configured to receive the frame from the communication network; a determination unit configured to determine whether the frame received by the reception unit is a valid frame or an invalid frame which is not a valid frame; and a transmission unit configured to transmit, if the determination unit determines that the received frame is an invalid frame, a frame including information identical to that included in the valid frame.

Therefore, in the arrangement according to the first to third aspects of the present invention, it is possible to readily disable the influence of a detected invalid frame by a simple arrangement.

Further features of the present invention will become apparent from the following description of exemplary embodiments (with reference to the attached drawings).

### BRIEF DESCRIPTION OF THE DRAWINGS

FIG. 1 is a block diagram showing the arrangement of an in-vehicle network according to an exemplary embodiment of the present invention.

FIG. 2 is a view for explaining a method in which ECU1 processes a received frame.

FIG. 3 is a flowchart illustrating monitoring processing executed by the monitoring apparatus of ECU0.

FIG. 4 is a flowchart illustrating update processing based on a received frame, which is executed by the control program of ECU1; and

FIG. 5 is a block diagram showing the arrangement of an in-vehicle network in which a monitoring apparatus is configured to centrally monitor frames transmitted/received by a plurality of ECUs connected to a CAN bus.

### DESCRIPTION OF THE EMBODIMENTS

Exemplary embodiments of the present invention will now be described in detail in accordance with the accompanying drawings.

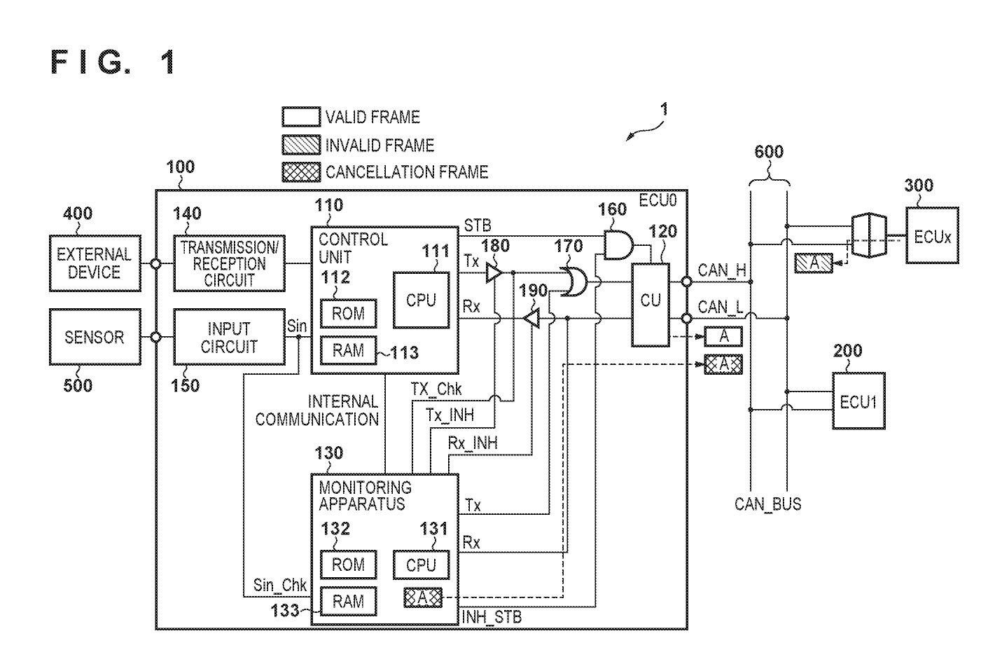

FIG. 1 is a block diagram showing the arrangement of an in-vehicle network according to an exemplary embodiment of the present invention.

As shown in FIG. 1, an in-vehicle network (to be referred to as a network hereinafter) 1 implements data communication when a plurality of ECUs (Electronic Control Units: control apparatuses) 100, 200, and 300 connected to a CAN bus 600 transmit/receive frames complying with the standard of the CAN bus. Note that for the sake of descriptive simplicity, the three ECUs are connected in this example. However, more ECUs are connected to an actual vehicle.

In the network 1, a monitoring apparatus 130 is incorporated in the ECU 100 (ECU0) for data security, and monitors the network 1. An external device 400 and a sensor 500 are connected to the ECU 100, and the operation of the external device 400 is electronically controlled based on, for example, a signal input from the sensor 500 or information from another ECU.

The ECU 100 includes a control unit 110, a communication unit (CU) 120 for controlling communication via the CAN bus 600, the monitoring apparatus 130 for monitoring the network, a transmission/reception circuit 140 serving as an interface with the external device 400, and an input unit 150 serving as an interface with the sensor 500. The control unit 110 includes a CPU 111 for controlling the overall operation of the ECU 100, a ROM 112 storing a control program executed by the CPU 111, and a RAM 113 serving as a work area when the CPU 111 executes the control program. The ROM 112 includes a nonvolatile memory such as an EEPROM in which contents are rewritable. The monitoring apparatus 130 also incorporates a CPU 131, a ROM 132, and a RAM 133. The control unit 110 and the monitoring apparatus 130 can confirm the state of one another by monitoring it by internal communication.

The communication unit (CU) 120 can operate when a control signal STB from the control unit 110 and a control signal INH_STB from the monitoring apparatus 130 are input to an AND circuit 160 and both signals are turned on.

Switch (SW) elements 180 and 190 are provided between the control unit 110 and the communication unit (CU) 120. The switch (SW) element 180 connects or blocks a transmission signal Tx output from the control unit 110, and the switch (SW) element 190 connects or blocks a reception signal Rx received by the communication unit (CU) 120. The operations of the switch (SW) elements 180 and 190 are respectively controlled by control signals Tx_INH and Rx_INH output from the monitoring apparatus 130.

As is apparent from the arrangement shown in FIG. 1, the transmission signal Tx from the control unit 110 and a transmission signal Tx from the monitoring apparatus 130 are input to an OR circuit 170, and one of a signal transmitted based on the transmission signal Tx from the control unit 110 and the signal transmitted from the monitoring apparatus 130 is output from the communication unit (CU) 120 to the CAN bus 600. On the other hand, the reception signal Rx received by the communication unit (CU) 120 is input to both the control unit 110 and the monitoring apparatus 130.

Note that input signals from the sensor 500 are respectively input as signals Sin and Sin_Chk to the control unit 110 and the monitoring apparatus 130.

A method in which the monitoring apparatus 130 monitors the network when the ECU (ECUx) 300 operates as an invalid apparatus which outputs a malicious invalid frame and the ECU (ECU1) 200 normally operates in the network having the above-described arrangement will be described next. In this embodiment, as ECUx operating as an invalid apparatus, any ECU which has an interface complying with the CAN bus standard and generates and transmits a frame transferable via the CAN bus is used. For example, an inspection apparatus which is connected to the CAN bus to maintain the vehicle may be used.

### Role of Monitoring Apparatus

(1) Detection of Invalid Frame

As is apparent from the arrangement shown in FIG. 1, via the signal Tx_Chk or the internal communication between the monitoring apparatus 130 and the control unit 110, the monitoring apparatus 130 can receive a frame (valid frame) transmitted by the control unit 110, and know a transmission source ID and control information contained in the frame. This allows the monitoring apparatus 130 to monitor a frame transmitted by the control unit 110. Note that information about a valid frame received from the control unit 110 is stored in the RAM (memory) 133 of the monitoring apparatus 130.

Furthermore, as is apparent from the arrangement shown in FIG. 1, the communication unit (CU) 120 can receive a predetermined frame transmitted/received via the communication path of the CAN bus 600, and the received frame can be received by not only the control unit 110 but also the monitoring apparatus 130.

According to the technical specifications of the CAN bus, a transmitted/received frame contains a transmission source ID indicating a transmission source and control information. Therefore, the monitoring apparatus 130 compares the transmission source ID of the received frame with the valid frame stored in the RAM 133. If it is determined based on the result of the comparison that the transmission source ID is the same as the ID of the frame transmitted by the control unit 110, it is determined based on the control information whether the received frame is the frame transmitted from the self apparatus, that is, the control unit 110 of the ECU 100 or a frame (invalid frame) transmitted by another ECU which spoofs the self apparatus. For example, it is possible to determine whether the received frame is a valid or invalid frame by checking whether the reception timing of the received frame has a predetermined period or whether the control information of the received frame coincides with the control information sent by the control unit 110.

As described above, the monitoring apparatus 130 can monitor a frame transmitted/received via the CAN bus communication path, thereby detecting whether the frame has actually been transmitted by the self apparatus (ECU0).

(2) Transmission of Cancellation Frame

Each of all the ECUs connected by the CAN bus includes, in the RAM, a reception buffer for temporarily storing the received frame. The received frame is extracted from the reception buffer by LIFO (Last-In First-Out) control, and used to control each ECU. That is, the CPU of each ECU reads out a frame which has been stored most lately (recently) in the reception buffer, and performs control based on control information contained in the readout frame.

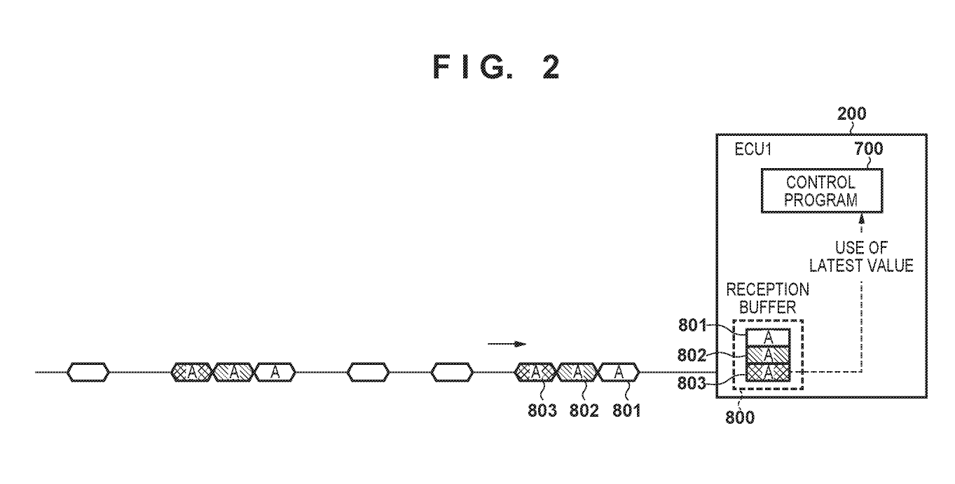

FIG. 2 is a view for explaining a method in which ECU1 processes the received frame.

FIG. 2 shows a case in which frames 801, 802, and 803 each having a transmission source ID “A” are successively received in the order named, and stored in a reception buffer 800 of the ECU (ECU1) 200. In this case, a control program 700 of the ECU 200 reads out the latest frame (in this example, the frame 803) among the received frames, and uses control information contained in the frame.

If the monitoring apparatus 130 detects an invalid frame, it immediately transmits a cancellation frame (to be described later) using the property in which the reception buffer of each ECU undergoes LIFO control.

For example, as shown in FIGS. 1 and 2, assume that the frame 801 is a valid frame transmitted from ECU0 to ECU1, the frame 802 is an invalid frame transmitted from ECUx to ECU1, and the frame 803 is a cancellation frame transmitted from ECU0 to ECU1. As described above, since the monitoring apparatus 130 monitors the communication path of the CAN bus, it can detect that the frame 802 is an invalid frame. In this case, the monitoring apparatus 130 immediately transmits the frame 803 containing the same control information as that of the frame 801.

Note that the control information of the frame 803 may be acquired from the control unit 110 by internal communication. Alternatively, an input (Sin) from the sensor 500 may be branched and input as a sensor signal (Sin Chk) to the monitoring apparatus 130, and the CPU 131 of the monitoring apparatus 130 may generate the same control information as that of the frame 801 based on the sensor signal.

As described above, ECU1 reads out the latest received frame from the reception buffer 800 and uses it for control. In this case, therefore, the frame 803 is read out and used for control, and the invalid frame is never used, thereby continuing correct control. Since the frame 803 has a function of canceling the influence of the frame 802, it is called a cancellation frame.

The in-vehicle network described in this embodiment has as its objective to normally operate the vehicle by acquiring pieces of information of various sensors mounted on the vehicle, generating control information of an actuator based on the pieces of sensor information, and transmitting the control information to other ECUs via the CAN bus. However, the vehicle has a unique property in which there is an allowable time from when a sensor detects given information until an actuator which reflects the information is driven to actually operate.

Consider, for example, a case in which the sensor 500 shown in FIG. 1 is a sensor for detecting the pressing amount of an accelerator pedal, and ECU1 serves as a control apparatus which plays a role of controlling the gear ratio of the automatic transmission of the vehicle based on the pressing amount. In this case, information about the pressing amount of the accelerator pedal is acquired from the sensor 500. If it is determined based on the pressing amount and information about the speed of the vehicle acquired from another sensor that the gear ratio needs to be lowered, the automatic transmission does not operate immediately to lower the gear ratio. There is a delay of about several “msec” due to the response time of the hydraulic pressure of the automatic transmission or the driving delay of the actuator before ECU0 processes the information received from the sensor 500, and transmits, as a frame, control information for the automatic transmission to ECU1, and the automatic transmission controlled by ECU1 starts an operation of changing the gear ratio. Therefore, even if ECU1 receives an invalid frame, if it receives a cancellation frame from ECU0 before the delay time elapses, the control program can use the control information of the newly received cancellation frame, and an erroneous operation caused by the invalid frame can be prevented.

For example, if a frame storing the control information of the transmission is transmitted/received at a period of 100 msec, and the control program updates the control information to latest information, a system in which an operation delay of about 300 msec is allowed can sufficiently prevent an erroneous operation caused by an invalid frame by transmitting a new frame. Referring back to FIG. 2, in terms of this point, if the frames 801 to 803 are transmitted/received at a period of 100 msec and the control program updates the control information, the cancellation frame by the frame 803 can sufficiently prevent an erroneous operation caused by the invalid frame 802.

The numerical values, sensors, and operations mentioned in the above description are merely illustrative, and appropriate values are set for electronic control of various parts of the vehicle, as a matter of course. In general, when the transmission/reception period of the frame and the update period of the control information are preset to be higher than the response speed of the actuator as a control target, the control program controls the operation based on not the control information of the invalid frame but the control information of the cancellation frame updated at the next update period.

Invalid frame monitoring processing and update processing of control information by a received frame, which are executed by ECU0 and ECU1, will be described next with reference to flowcharts.

### Monitoring Processing and Update Processing

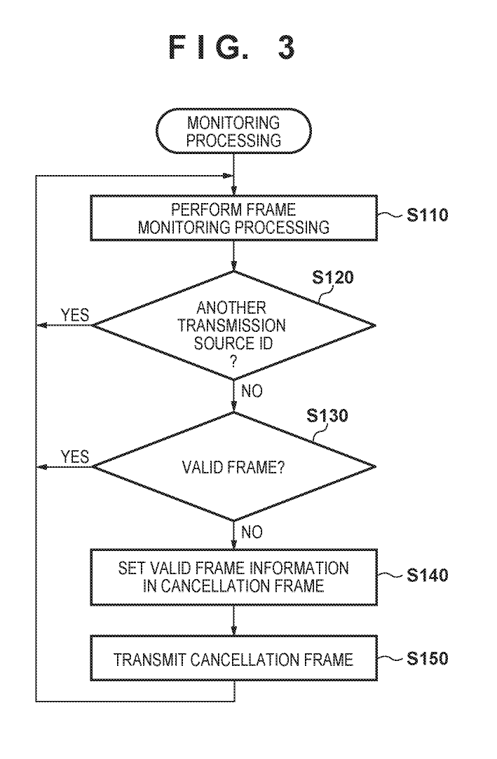

FIG. 3 is a flowchart illustrating monitoring processing executed by the monitoring apparatus 130 of ECU0.

During the operation of ECU0, the monitoring apparatus 130 monitors a frame transmitted/received via the communication path of the CAN bus 600 all the time. In step S110, therefore, the monitoring apparatus 130 monitors the CAN bus 600 which executes frame monitoring processing.

Next, in step S120, it is checked whether a frame received via the communication unit (CU) 120 is a valid frame transmitted by ECU0 (self apparatus). As described above, the monitoring apparatus 130 can confirm, by internal communication with the control unit 110, the frame transmitted by ECU0 and a transmission source ID and control information contained in the frame. Thus, the transmission source ID of the received frame is checked and then it is checked whether the transmission source ID is the same as the known transmission source ID of the self apparatus.

If the transmission source ID of the received frame is different from that of the self apparatus, the process returns to step S110 and the frame monitoring processing is continued. On the other hand, if the transmission source ID of the received frame is the same as that of the self apparatus, the process advances to step S130 and it is determined whether the received frame is a valid or invalid frame. In this example, it is possible to determine whether the received frame is a valid or invalid frame by checking, for example, whether the reception timing of the received frame has a predetermined period or whether the control information of the received frame coincides with the control information sent from the control unit 110. That is, if the reception period is different from the predetermined period or the control information contained in the frame is different from that transmitted by the self apparatus, the frame is determined as an invalid frame.

If the received frame is thus determined as a valid frame, the process returns to step S110 and the frame monitoring processing is continued. On the other hand, if the received frame is determined as an invalid frame, the process advances to step S140 and a cancellation frame is generated. That is, a cancellation frame is generated by setting the same control information as that set in the preceding transmission of a valid frame. In step S150, the generated cancellation frame is transmitted. After that, the process returns to step S110 and the frame monitoring processing is continued.

Note that the cancellation frame may be added with information indicating that the invalid frame has been transmitted, and then transmitted. This can give the ECU on the reception side a warning that the invalid frame has been transmitted. The ECU on the reception side can take a countermeasure when the invalid frame is received.

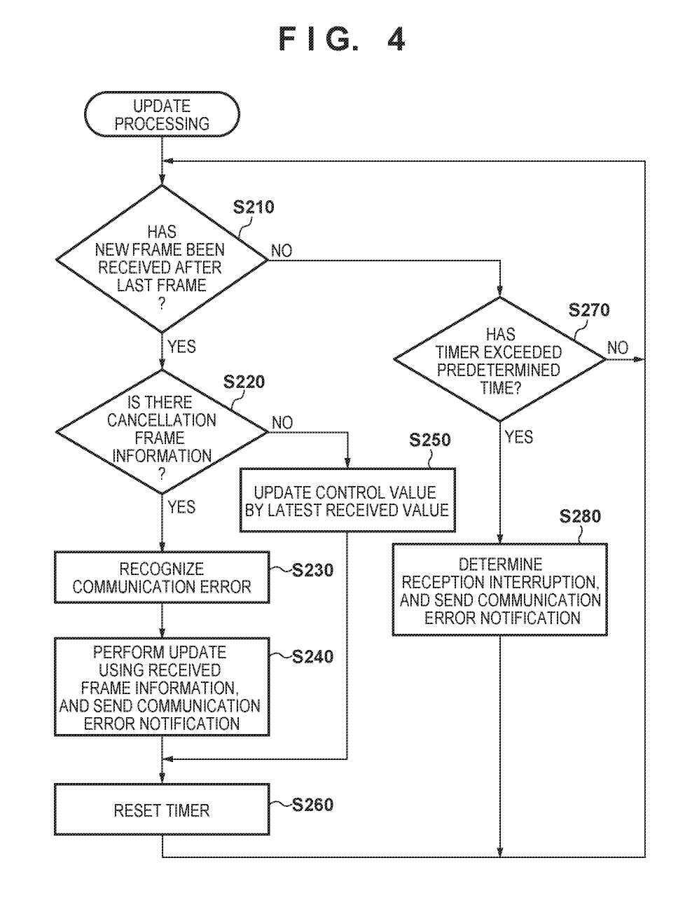

FIG. 4 is a flowchart illustrating update processing based on a received frame, which is executed by the control program of ECU1.

In step S210, it is checked whether a new frame has been received after the last frame reception. In consideration of control of the overall vehicle, there is a reception period assumed for each frame type, and it is thus possible to wait for frame reception using a timer in which a predetermined time is set. If it is determined that no frame has been received, the process advances to step S270 and it is checked whether the time counted by the timer has exceeded the predetermined time.

If it is determined that the predetermined time has not elapsed and monitoring by the timer continues, the process returns to step S210 to wait for frame reception. On the other hand, if it is determined that the predetermined time has elapsed and the timer has expired, the process advances to step

S280 and it is determined that an error has occurred in the CAN bus 600 and communication has been interrupted. After that, the process returns to step S210. This communication error may be caused by a failure of hardware such as disconnection of a signal line, the fact that it is detected that a plurality of frames collide with each other on the communication path and the collision count becomes equal to or larger than a predetermined count, the fact that a standby time for frame transmission generated by collision exceeds a predetermined time, or the like. Then, ECU1 attempts to notify another ECU that the communication error has occurred.

If it is determined in step S210 that the new frame has been received and stored in the reception buffer 800, the process advances to step S220. In step S220, it is checked whether there is information indicating that the received frame is a cancellation frame. If it is determined that there is no information indicating that the received frame is a cancellation frame, the process advances to step S250, and the control program 700 updates the control information by control information stored in the received frame, thereby obtaining the latest control information. After that, the process advances to step S260.

On the other hand, if it is determined that the new frame is a cancellation frame, the process advances to step S230. In step S230, since the received frame is a cancellation frame, it is recognized that an event (communication error) different from normal communication, such as transmission of an invalid frame, has occurred. Furthermore, since the received frame is a cancellation frame and the information set in the frame is valid control information, the control program 700 updates, in step S240, the control information by the control information stored in the received frame, thereby obtaining the latest control information. Furthermore, the control program 700 notifies another ECU of the occurrence of the communication error.

After that, the process advances to step S260 and the timer is reset. Then, the process returns to step S210 to wait for reception of the next frame.

According to the above-described embodiment, it is possible to determine whether the received frame monitored by the monitoring apparatus provided in the ECU is an invalid frame, and if an invalid frame is detected, it is possible to transmit a frame which cancels the invalid frame. On the other hand, although the ECU which receives the frame successively receives frames, the latest frame is read out from the reception buffer and used for control. Thus, even if an invalid frame is received, there is a delay to some extent before the received frame is used to perform target control. Consequently, it is possible to prevent, using the control information of a cancellation frame received thereafter, an erroneous operation from occurring due to the invalid frame, thereby performing correct control.

### Other Embodiments

The above-described embodiment has exemplified the arrangement in which the monitoring apparatus provided in the ECU detects an invalid frame. However, the present invention is not limited to this. In this embodiment, detection of an invalid frame and prevention of an erroneous operation caused by the invalid frame in an arrangement in which a monitoring apparatus is provided outside an ECU and directly connected to the communication path of a CAN bus will be described.

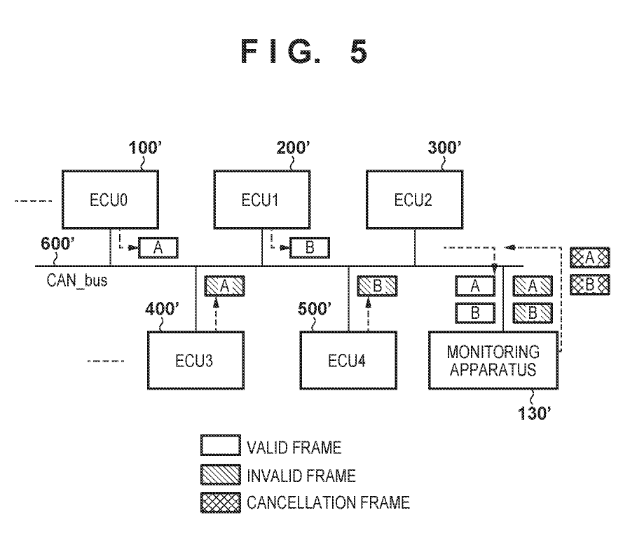

FIG. 5 is a block diagram showing the arrangement of an in-vehicle network in which a monitoring apparatus is configured to centrally monitor frames transmitted/received by a plurality of ECUs connected to the CAN bus.

In an example shown in FIG. 5, assume that five ECUs (ECU0 to ECU4) 100′, 200′, 300′, 400′, and 500′ and a monitoring apparatus 130′ are connected to a CAN bus 600′. Assume also that the ECU 100′ transmits a valid frame with a transmission source ID “A”, the ECU 200′ transmits a valid frame with a transmission source ID “B”, the ECU 300′ operates as an invalid apparatus, and transmits an invalid frame with a transmission source ID “A”, and the ECU 400′ operates as an invalid apparatus, and transmits an invalid frame with a transmission source ID “B”.

On the other hand, the monitoring apparatus 130′ receives all the frames transmitted/received via the CAN bus 600′, similarly to the above-described embodiment. The monitoring apparatus 130′ then monitors whether the frame is received at a period determined in accordance with a frame type. For example, as described in the above embodiment, a frame storing the control information of an automatic transmission is transmitted/received at a period of 100 msec. In this case, it can be estimated that the next valid frame is received 100 msec after a valid frame is received at a given timing. By using this property, the monitoring apparatus 130′ according to this embodiment detects reception of an invalid frame.

That is, the reception time of the received frame in the reception buffer (not shown) of the monitoring apparatus 130′ is checked and it is checked whether the reception time has a predetermined period. A frame received at a timing which has a period other than the predetermined period is determined as an invalid frame. If an invalid frame is detected, a cancellation frame is generated using control information stored in a frame (valid frame) received immediately before and the transmission destination ID of the frame, and transmitted.

Note that with respect to detection of an invalid frame, the method of detecting a frame received at a period other than the predetermined period is not intended to limit the present invention. For example, another method may be used, in which the number of frames necessary for one control operation of a specific part of a vehicle or the like is set as an index, and when the necessary number or more of frames are received, the frame is determined as an invalid frame. The monitoring apparatus 130′ may be connected to a CAN bus 601′ (not shown) different from the CAN bus 600′, and may have a function as a gateway apparatus which mediates communication of a frame between the CAN buses 600′ and 601′.

According to the above-described embodiment, therefore, an irregularly generated invalid frame can be detected using a monitoring apparatus connected to the CAN bus independently of the ECU, and a cancellation frame can be generated and transmitted. This makes it possible to prevent an erroneous operation from occurring due to an invalid frame, and perform correct control, similarly to the above-described embodiment.

### Summary of Embodiments

Arrangement 1

There is provided a monitoring apparatus (130; 130′) for monitoring a frame transmitted/received via a communication network (600), comprising a reception unit (120) configured to receive the frame from the communication network, a determination unit (131) configured to determine whether the frame received by the reception unit is a valid frame (801) or an invalid frame (802) which is not a valid frame, and a transmission unit (120) configured to transmit, if the determination unit determines that the received frame is an invalid frame, a frame (803) including information identical to that included in the valid frame.

Arrangement 2

There is provided the monitoring apparatus (130) wherein the monitoring apparatus (130) is incorporated in a control apparatus (100) connected to the communication network.

Arrangement 3

There is provided the monitoring apparatus wherein the monitoring apparatus and the control apparatus are connected by internal communication different from the communication network, the monitoring apparatus further includes a memory (133) which receives a valid frame, which the control apparatus holds as a valid frame of a valid transmission source, from the control apparatus via the internal communication, and stores the valid frame, and the determination unit compares the valid frame stored in the memory with the frame received by the reception unit, and determines, based on a result of the comparison, whether the received frame is a valid frame or an invalid frame.

Arrangement 4

There is provided the monitoring apparatus wherein the determination unit checks whether reception time of the frame received by the reception unit has a predetermined period, and determines, as an invalid frame, a frame received at a period other than the predetermined period.

Arrangement 5

There is provided the monitoring apparatus (130′) wherein the monitoring apparatus is connected to the communication network independently of a control apparatus, connected to the communication network, for transmitting/receiving a frame, and receives a frame from the control apparatus via the communication network.

Arrangement 6

There is provided the monitoring apparatus wherein the determination unit checks whether reception time of a frame received by the reception unit has a predetermined period, and determines, as an invalid frame, a frame received at a period other than the predetermined period.

Arrangement 7

There is provided the monitoring apparatus wherein the communication network is an in-vehicle network for transmitting/receiving a frame complying with a standard of a CAN bus, and the frame contains a transmission source ID indicating a transmission source of the frame, and control information.

Arrangement 8

There is provided the monitoring apparatus wherein a control apparatus (200) on a reception side of the frame, which is connected to the communication network, includes a reception buffer (800), the reception buffer sequentially stores received frames, and the control apparatus on the reception side reads out a latest received frame among the frames stored in the reception buffer, from the reception buffer, and executes control based on control information contained in the latest received frame.

Arrangement 9

There is provided the monitoring apparatus wherein the transmission unit transmits a frame including information identical to that included in the valid frame after the control apparatus on the reception side receives the invalid frame and before the control apparatus on the reception side reads out the invalid frame as the latest received frame.

Arrangement 10

There is provided a communication system (1) comprising a plurality of control apparatuses (100, 200, 300), each integrating a monitoring apparatus defined in arrangement 1, and transmitting/receiving a frame via a communication path from a network.

Arrangement 11

There is provided a communication system (1) comprising: a monitoring apparatus configured to be connected to a communication path from a network; and a control apparatus configured to transmit/receive a frame via the communication path, wherein the monitoring apparatus is defined in arrangement 1.

According to arrangements 1 to 11 described above, it is possible to disable the effect of a detected invalid frame by a simple arrangement.

According to arrangements 2 to 4 described above, it is possible to incorporate the monitoring apparatus in the control apparatus.

According to arrangements 5 to 6 described above, it is possible to connect the monitoring apparatus to the network independently of the control apparatus and use it.

According to arrangements 7 to 9 described above, it is possible to incorporate the monitoring apparatus in the in-vehicle network, and disable an invalid frame entering the in-vehicle network.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-051517, filed Mar. 15, 2016, which is hereby incorporated by reference herein in its entirety.

What is claimed is:

1. A monitoring apparatus for monitoring a frame transmitted/received via a communication network, comprising:
a reception unit configured to receive the frame from the communication network;
a determination unit configured to determine whether the frame received by the reception unit is a valid frame or an invalid frame which is not a valid frame; and
a transmission unit configured to transmit, if the determination unit determines that the received frame is an invalid frame, a frame including information identical to that included in the valid frame.

2. The monitoring apparatus according to claim 1, wherein the monitoring apparatus is incorporated in a control apparatus connected to the communication network.

3. The monitoring apparatus according to claim 2, wherein the monitoring apparatus and the control apparatus are connected by internal communication different from the communication network,
the monitoring apparatus further includes a memory which receives a valid frame, which the control apparatus holds as a valid frame of a valid transmission source, from the control apparatus via the internal communication, and stores the valid frame, and
the determination unit compares the valid frame stored in the memory with the frame received by the reception unit, and determines, based on a result of the comparison, whether the received frame is a valid frame or an invalid frame.

4. The monitoring apparatus according to claim 2, wherein the determination unit checks whether reception time of the frame received by the reception unit has a predetermined period, and determines, as an invalid frame, a frame received at a period other than the predetermined period.

5. The monitoring apparatus according to claim 1, wherein the monitoring apparatus is connected to the communication network independently of a control apparatus, connected to the communication network, for transmitting/receiving a frame, and receives a frame from the control apparatus via the communication network.

6. The monitoring apparatus according to claim 5, wherein the determination unit checks whether reception time of a frame received by the reception unit has a predetermined period, and determines, as an invalid frame, a frame received at a period other than the predetermined period.

7. The monitoring apparatus according to claim 1, wherein the communication network is an in-vehicle network for transmitting/receiving a frame complying with a standard of a CAN bus, and
the frame contains a transmission source ID indicating a transmission source of the frame, and control information.

8. The monitoring apparatus according to claim 7, wherein a control apparatus on a reception side of the frame, which is connected to the communication network, includes a reception buffer,
the reception buffer sequentially stores received frames, and
the control apparatus on the reception side reads out a latest received frame among the frames stored in the reception buffer, from the reception buffer, and executes control based on control information contained in the latest received frame.

9. The monitoring apparatus according to claim 8, wherein the transmission unit transmits a frame including information identical to that included in the valid frame after the control apparatus on the reception side receives the invalid frame and before the control apparatus on the reception side reads out the invalid frame as the latest received frame.

10. A communication system comprising:
a plurality of control apparatuses, each integrating a monitoring apparatus, and transmitting/receiving a frame via a communication path, wherein the monitoring apparatus monitors the frame transmitted/received via the communication network from a network, and comprises:
a reception unit configured to receive the frame from the communication network;
a determination unit configured to determine whether the frame received by the reception unit is a valid frame or an invalid frame which is not a valid frame; and
a transmission unit configured to transmit, if the determination unit determines that the received frame is an invalid frame, a frame including information identical to that included in the valid frame.

11. A communication system comprising:
a monitoring apparatus configured to be connected to a communication path; and
a control apparatus configured to transmit/receive a frame via the communication path,
wherein the monitoring apparatus monitors a frame transmitted/received via the communication path from a communication network, and comprises:
a reception unit configured to receive the frame from the communication network;
a determination unit configured to determine whether the frame received by the reception unit is a valid frame or an invalid frame which is not a valid frame; and
a transmission unit configured to transmit, if the determination unit determines that the received frame is an invalid frame, a frame including information identical to that included in the valid frame.
